(19) United States
(12) Patent Application Publication
(10) Pub. No.: US 2012/0297095 A1
(43) Pub. Date: Nov. 22, 2012

(54) DMA CONTROL DEVICE AND IMAGE FORMING APPARATUS

(75) Inventor: Akihiro Namera, Osaka (JP)

(73) Assignee: SHARP KABUSHIKI KAISHA, Osaka (JP)

(21) Appl. No.: 13/471,916

(22) Filed: May 15, 2012

(30) Foreign Application Priority Data
May 16, 2011 (JP) 2011-109016

(51) Int. Cl. G06F 13/28

(52) U.S. Cl. 710/22

(57) ABSTRACT

Provided is efficiently performing DMA transfer of data without causing heavy overhead to occur. A data transfer detecting portion detects data transfer from an external device to a predetermined memory area in a memory; and a DMA execution instructing portion instructs, when the data transfer to the memory area is detected by the data transfer detecting portion, an image processing DMA controller to start execution of the direct memory access transfer of data from the above memory area to an image processing dedicated memory.

### CROSS-NOTING PARAGRAPH

This non-provisional application claims priority under 35 U.S.C. §119 (a) on Patent Application No. 2011-109016 filed in JAPAN on May 16, 2011, the entire contents of which are hereby incorporated herein by reference.

### FIELD OF THE INVENTION

The present invention relates to a DMA control device which controls direct memory access from a predetermined memory area to a predetermined device, and an image forming apparatus provided with the DMA control device.

### BACKGROUND OF THE INVENTION

It has been carried out conventionally in an image forming apparatus such as a printer or a multifunction peripheral that data input from an external device is once stored in a memory and the data stored in the memory is transferred by DMA (Direct Memory Access) to a processing portion which performs image processing. Then, in recent years, since an amount of data to be treated by an image forming apparatus has been increased and a processing speed of image processing in an image processing device has also been improved, data is required to be transferred more efficiently.

For example, Japanese Laid-Open Patent Publication No. 2005-4563 discloses a DMA transfer control device which measures each DMA transfer speed of a plurality of DMA controllers, and gives priority to DMA transfer of the DMA controller with the DMA transfer speed which is less than a predetermined setting value, while suppressing DMA transfer of the remaining DMA controllers, so as to improve data transfer efficiency of DMA.

In addition, Japanese Laid-Open Patent Publication No. 2001-312457 discloses a data processing system which uses an address counter which is managed by a DMA controller to monitor an address, and performs a plurality of data signal processing in parallel while performing overtaking prohibition control processing so that latter data signal processing does not overtake former data signal processing.

However, in a case where data input from an external device is once stored in a memory by a host controller of the external device and the DMA controller transfers the data stored in the memory to a processing portion to perform image processing by DMA, the DMA controller is not involved in the storage processing of the data to the memory, and it is thus difficult for the DMA controller to determine that at which point the above transfer should be started.

To allow the DMA controller to start the above transfer, processing is required such that after completion of storage of data to the memory, the host controller notifies a CPU (Central Processing Unit) of an image forming apparatus of completion of storage of the data, and the CPU receiving the notification instructs the DMA controller to start data transfer.

Therefore, assuming that the technology disclosed in Japanese Laid-Open Patent Publication No. 2005-4563 or Japanese Laid-Open Patent Publication No. 2001-312457 is applied to transfer by the DMA, communication processing between the host computer and the CPU is required so that heavy overhead occurs, thus making it impossible to efficiently transfer data.

### SUMMARY OF THE INVENTION

An object of the present invention is to provide a DMA control device which is able to perform DMA transfer of data efficiently without causing heavy overhead to occur, and an image forming apparatus provided with the DMA control device.

An object of the present invention is to provide a DMA control device which controls direct memory access transfer of data from a predetermined memory area to a predetermined device, comprising: a data transfer detecting portion which detects data transfer from an external device to the memory area; and a DMA execution instructing portion which instructs a DMA controller to start execution of the direct memory access transfer when the data transfer to the memory area is detected by the data transfer detecting portion.

Another object of the present invention is to provide the DMA control device, wherein the data transfer detecting portion receives specification of the memory area to which the external device performs the data transfer, and detects the data transfer to the specified memory area.

Another object of the present invention is to provide the DMA control device, wherein the DMA execution instructing portion outputs a signal indicating that there is no data transfer in a case where the data transfer is not detected by the data transfer detecting portion for a certain period of time.

Another object of the present invention is to provide the DMA control device, wherein the data transfer detecting portion detects whether or not a transfer amount of the data transferred by the data transfer exceeds a predetermined value, and the DMA execution instructing portion instructs the DMA controller to start execution of the direct memory access transfer when it is detected by the data transfer detecting portion that the transfer amount exceeds the predetermined value.

Another object of the present invention is to provide an image forming apparatus provided with the DMA control device.

### BRIEF DESCRIPTION OF THE DRAWINGS

FIG. 1 is a diagram showing an example of a configuration of an image processing system provided with a DMA control device;

FIG. 2 is a diagram explaining an exchange of image data in DMA control processing according to the present embodiment;

FIG. 3 is a flowchart showing an example of a processing procedure in the DMA control processing according to the present invention; and

FIG. 4 is a flowchart showing an example of processing procedure in the DMA control processing according to the present invention.

### PREFERRED EMBODIMENTS OF THE INVENTION

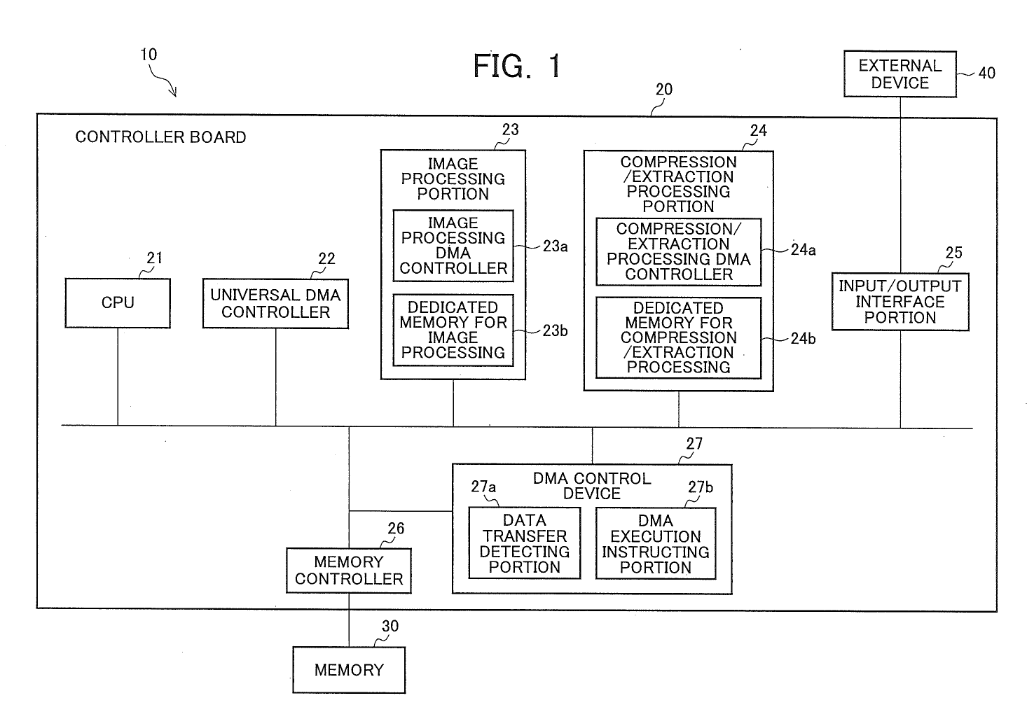

Hereinafter, description will be given in detail for an embodiment of the present invention with reference to the drawings. First, description will be given for an example of a configuration of a DMA control device according to the present invention. FIG. 1 is a diagram showing an example of a configuration of an image processing system 10 provided with a DMA control device 27. The image processing system 10 is a system to be mounted on an image forming apparatus such as, for example, a printer, a copier, a FAX machine, and an MFP (Multi Function Peripheral).

As shown in FIG. 1, the image processing system 10 includes a controller board 20, a memory 30, and an external device 40. The controller board 20 is a control board which controls image processing. The memory 30 is a memory such as a DRAM (Dynamic Random Access Memory) which stores image data divided into a plurality of blocks and the like. The external device 40 is a device which divides image data into a plurality of blocks and stores each block of the image data in the memory 30.

The controller board 20 is provided with a CPU (Central Processing Unit) 21, a universal DMA (Direct Memory Access) controller 22, an image processing portion 23, a compression/extraction processing portion 24, an input/output interface portion 25, a memory controller 26, and a DMA control device 27.

The CPU 21 is a control portion which controls respective function portions on the controller board 20. The CPU 21 obtains a parameter required by a device (for example, external device 40, etc.) to access the memory 30 from the device and performs processing to set the parameter to a register (not shown) of the DMA control device 27 which will be explained below.

Here, the parameter required by the device to access the memory 30 is information of a device which transfers data to the memory 30, a memory area of the memory 30 in which the device writes image data, a block size of image data transmitted by the device, the number of blocks of image data transmitted by the device, and an image processing DMA controller 23a which is given an instruction to start execution of direct memory access by the DMA control device 27.

The universal DMA controller 22 is a processing portion which performs DMA transfer between memories (not shown) mounted on the controller board 20, or between the memory 30 and the memory mounted on the controller board 20, not through the CPU 21.

The image processing portion 23 is a processing portion which performs image processing for image data stored in the memory 30. The image processing portion 23 is provided with the image processing DMA controller 23a and an image processing dedicated memory 23b. The image processing DMA controller 23a is a processing portion which performs DMA transfer of image data from the memory 30 to the image processing dedicated memory 23b not through the CPU 21.

The compression/extraction processing portion 24 is a processing portion which performs encoding and decoding of an image subjected to image processing by the image processing portion 23. The compression/extraction processing portion 24 is provided with a compression/extraction processing DMA controller 24a and a compression/extraction processing dedicated memory 24b. The compression/extraction processing portion 24a is a processing portion which performs DMA transfer of the image data subjected to image processing by the image processing portion 23 from the memory 30 to the compression/extraction processing dedicated memory 24b not through the CPU 21.

The input/output interface portion 25 is an interface which performs communication with the external device 40. The input/output interface portion 25 performs communication by PCI Express, for example. The memory controller 26 is a processing portion which controls access from the external device 40 to the memory 30.

The DMA control device 27 is a device which controls DMA transfer of a DMA controller. The DMA control device 27 is provided with a data transfer detecting portion 27a and a DMA execution instructing portion 27b.

The data transfer detecting portion 27a is a processing portion which detects transfer of image data to the memory 30 from the external device 40 which is set by the CPU 21 as the device which transfers image data. The data transfer detecting portion 27a receives specification of a memory area in the memory 30 in which image data is written by the external device 40, via a register (not shown) in the DMA control device 27 described above. The data transfer detecting portion 27a then detects transfer of the image data to the specified memory area.

Thereby, even when a plurality of image data which should be processed are transferred from the external device 40, it is possible to distinguish transfer of each image data so as to detect the transfer of only the image data to be processed.

The DMA execution instructing portion 27b is a processing portion which instructs, when transfer of image data from the external device 40 to the memory 30 is detected by the data transfer detecting portion 27a, the image processing DMA controller 23a which is set by the CPU 21 as a target which is instructed to start execution of DMA transfer to start execution of DMA transfer to the image processing dedicated memory 23b.

The DMA execution instructing portion 27b further performs processing to output to the CPU 21a signal indicating that there is no transfer of image data, in a case where there is an error occurred in transferring the image data by the external device 40 so that transfer of the image data is not detected by the data transfer detecting portion 27a for a certain period of time. The CPU 21 which receives such a notification performs, for example, processing to request external device 40 to retransmit image data.

Note that, like the present embodiment, in a case where image data is transferred by being divided into a plurality of data blocks, the data transfer detecting portion 27a detects whether or not a transfer amount of the data exceeds a size of the data block. The data block is a block of data in a minimum size allowing the image processing portion 23 and the compression/extraction processing portion 24 to execute image processing and compression/extraction processing.

The DMA execution instructing portion 27b then instructs the image processing DMA controller 23a to start execution of DMA transfer, every time a transfer amount of data exceeds a value of a size of a data block concerning each data block.

In this manner, when there is an error occurred in transferring image data by the external device 40, and there is no transfer of image data for a certain period of time, the DMA execution instructing portion 27b outputs a signal indicating there is no transfer of image data, thereby it is possible to cause the CPU 21 and the like to execute appropriate processing for preventing system stop.

Moreover, since the DMA execution instructing portion 27b instructs the image processing DMA controller 23a to start execution of DMA transfer every time a transfer amount of data exceeds a value of a size of the data block concerning each data block, the DMA transfer of data to the image processing dedicated memory 23b of the image processing portion 23 is thereby executed every time an executable amount of data subjected to image processing is stored, and therefore, it is possible for the image processing portion 23 to execute image processing efficiently without bringing the image processing portion 23 to be in an idling state.

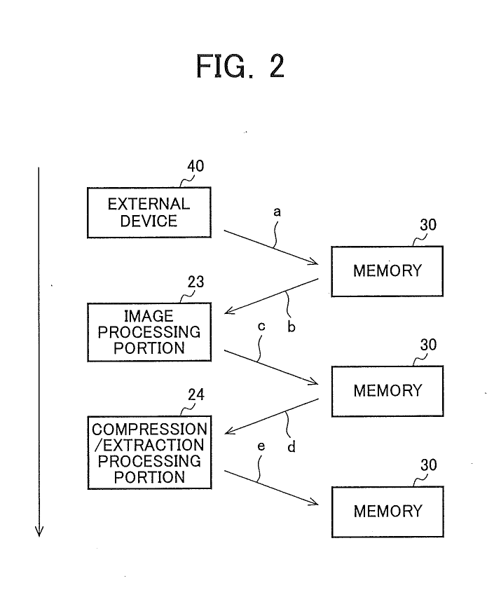

Here, in DMA control processing according to the present embodiment, an exchange of image data is carried out as described below among the memory 30, the external device 40, the image processing portion 23 and the compression/extraction processing portion 24. FIG. 2 is a diagram explaining an exchange of image data in DMA control processing according to the present embodiment.

As shown in FIG. 2, first, image data is transferred from the external device 40 to the memory 30, and stored in the memory (a in FIG. 2). The data transfer detecting portion 27a instructs, in the case of detecting transfer of the image data, the image processing DMA controller 23a which is provided to the image processing portion 23 to transfer image data from the memory 30 to the image processing dedicated memory 23b. In accordance with the instruction, the image processing DMA controller 23a transfers the image data from the memory 30 to the image processing portion 23 (b in FIG. 2).

When image processing of the image data is performed by the image processing portion 23, the image data subjected to image processing is stored in the memory 30 (c in FIG. 2). Then, the image processing portion 23 notifies the compression/extraction processing DMA controller 24a of the compression/extraction processing portion 24 of storage of the image data after execution of image processing in the memory 30.

The compression/extraction processing DMA controller 24a which receives the notification transfers the image data after execution of image processing stored in the memory 30 to the compression/extraction processing dedicated memory 24b by DMA transfer (d in FIG. 2). Thereafter, the compression/extraction processing portion 24 performs encoding processing of the image data after execution of image processing and stores the image data subjected to encoding processing in the memory 30 (e in FIG. 2).

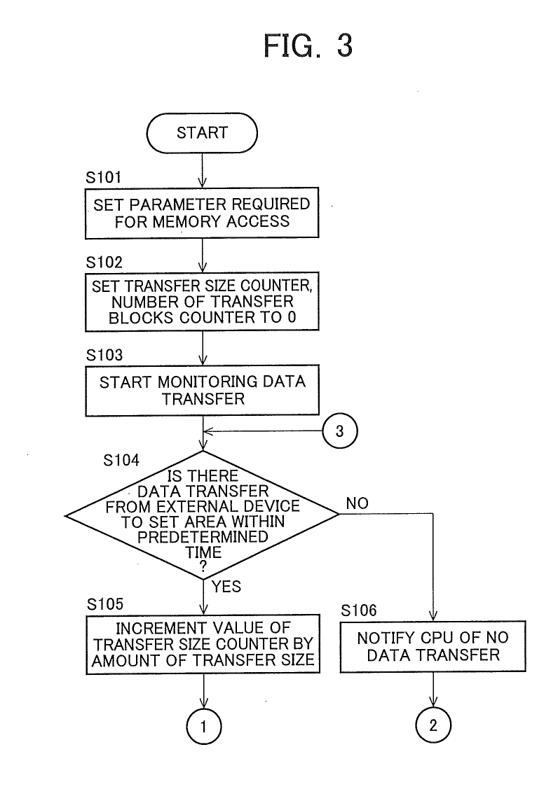

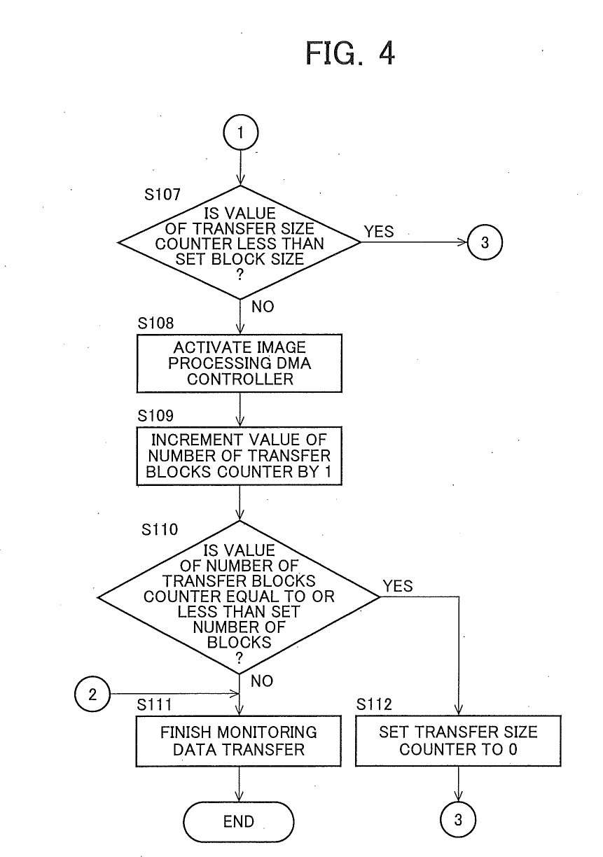

Next, description will be given for an example of a processing procedure of DMA control processing according to the present invention. FIG. 3 and FIG. 4 are flowcharts showing an example of a processing procedure of DMA control processing according to the present invention. As shown in FIG. 3, first, the CPU 21 sets to a register of the DMA control device 27 a parameter required by the external device 40 to access the memory 30 (step S101).

Here, the parameter required by the external device 40 to access the memory 30 is information of the external device 40 which transfers data to the memory 30, a memory area of the memory 30 in which the external device 40 writes image data, a block size of image data transmitted by the external device 40, the number of blocks of image data transmitted by the external device 40, and the image processing DMA controller 23a which is instructed by the DMA control device 27 to start executing direct memory access.

The data transfer detecting portion 27a thereafter sets values of a transfer size counter and a number of transfer blocks counter to 0 (step S102). The data transfer detecting portion 27a then starts monitoring of data transfer from the external device 40 to the memory area set at step S101 (step S103).

The data transfer detecting portion 27a then determines whether or not there is data transfer from the external device 40 to the memory area set at step S101 within a predetermined time (step S104).

When there is no data transfer from the external device 40 to the memory area set at step S101 within a predetermined time (in the case of NO at step S104), the DMA execution instructing portion 27b notifies the CPU 21 of no data transfer from the external device 40 to the memory area set at step S101 (step S106).

The CPU 21 which received this notification, for example, performs processing to request the external device 40 to retransmit image data. The data transfer detecting portion 27a then finishes monitoring the data transfer (step S111), and the DMA control processing is finished.

At step S104 in FIG. 3, when there is data transfer from the external device 40 to the memory area set at step S101 within a predetermined time (in the case of YES at step S104), the data transfer detecting portion 27a increments the value of the transfer size counter by an amount of a size of the transferred image data (step S105).

Thereafter, as shown in FIG. 4, the data transfer detecting portion 27a determines whether or not a value of the transfer size counter is less than the block size set at step S101 in FIG. 3 (step S107).

When the value of the transfer size counter is less than the block size set at step S101 in FIG. 3 (in the case of YES at step S107), the process shifts to step S104 in FIG. 3 and subsequent processing is executed.

When the value of the transfer size counter is not less than the block size set at S101 in FIG. 3 (in the case of NO at step S107), the DMA execution instructing portion 27b instructs the image processing DMA controller 23a to start execution of DMA transfer of the data blocks of the image data stored in the memory 30, thereby activating the image processing DMA controller 23a (step S108).

Thereby, one of the data blocks of the image data stored in the memory 30 is transferred to the image processing dedicated memory 23b by DMA transfer and image processing to the data block is performed by the image processing portion 23.

After the processing at step S108, the data transfer detecting portion 27a increments a value of the number of transfer blocks counter by 1 (step S109). The data transfer detecting portion 27a then determines whether or not the value of the number of transfer blocks counter is the number of blocks of the image data set at step S101 in FIG. 3 or less (step S110).

In the case where the value of the number of transfer blocks counter is the number of blocks of the image data set at step S101 or less (in the case of YES at step S110), the data transfer detecting portion 27a sets the value of the transfer size counter to 0 (step S112). The process then shifts to the step S104 in FIG. 3, and subsequent processing is executed.

In the case where the value of the number of transfer blocks counter is the number of blocks of the image data set at step S101 or less (in the case of YES at step S110), the data transfer detecting portion 27a finishes monitoring the data transfer (step S111), and the DMA control processing is finished.

Hereinabove, description has been given for the embodiment of the present invention, however, the present invention is not limited to the above-described embodiment, and may variously be modified and altered within the scope, without departing from the spirit of the present invention. For example, in the above embodiments, it is assumed that the image processing portion 23 includes the image processing DMA controller 23a, however, the image processing DMA controller 23a may be provided independently from the image processing portion 23. Additionally it is assumed that the compression/extraction processing portion 24 is provided with the compression/extraction processing DMA controller 24a, however, the compression/extraction processing DMA controller 24a may be provided independently from the compression/extraction processing portion 24.

Moreover, according to the present invention, when data transfer from an external device to a predetermined memory area in a memory is detected, an instruction to start execution of direct memory access transfer is given to a DMA controller, thereby it is possible to perform DMA transfer of data efficiently without causing heavy overhead to occur.

1. A DMA control device which controls direct memory access transfer of data from a predetermined memory area to a predetermined device, comprising:
a data transfer detecting portion which detects data transfer from an external device to the memory area; and
a DMA execution instructing portion which instructs a DMA controller to start execution of the direct memory access transfer when the data transfer to the memory area is detected by the data transfer detecting portion.

2. The DMA control device as defined in claim 1, wherein,
the data transfer detecting portion receives specification of the memory area to which the external device performs the data transfer, and detects the data transfer to the specified memory area.

3. The DMA control device as defined in claim 1, wherein,
the DMA execution instructing portion outputs a signal indicating that there is no data transfer in a case where the data transfer is not detected by the data transfer detecting portion for a certain period of time.

4. The DMA control device as defined in claim 1, wherein,
the data transfer detecting portion detects whether or not a transfer amount of the data transferred by the data transfer exceeds a predetermined value, and the DMA execution instructing portion instructs the DMA controller to start execution of the direct memory access transfer when it is detected by the data transfer detecting portion that the transfer amount exceeds the predetermined value.

5. An image forming apparatus provided with the DMA control device as defined in claim 1.
